(19) United States
(12) Patent Application Publication
(10) Pub. No.: US 2021/0228029 A1
(43) Pub. Date: Jul. 29, 2021

(54) Grill Tool with Music Player Controller

(71) Applicant: Just Because Design Limited, LLC., Auckland (NZ)

(72) Inventor: Simon Morgan, Auckland (NZ)

(21) Appl. No.: 16/776,114

(22) Filed: Jan. 29, 2020

(51) Int. Cl. A47J 43/28; A47J 37/07; G06F 3/16

(52) U.S. Cl. CPC A47J 43/288; G06F 3/165; A47J 37/0786

(57) ABSTRACT

A grill tool for controlling music being streamed from a portable electronic device to a speaker has a grill tool head mounted on a rigid elongate handle, and a music player controller mounted on the rigid elongate handle. The music player controller has a microcontroller operably connected to a battery, and a button-controlled panel for controlling the music being streamed from the portable electronic device.

### BACKGROUND OF THE INVENTION

### Field of the Invention

This invention relates generally to grill tools, and more particularly to a grill tool which includes a music player controller for playing audio on a speaker.

### Description of Related Art

Grill tools (i.e., spatulas, brushes, tongs, etc.) are well-established in the art as having an exclusive function of handling food or related grilling items, including some grilling tools with removable handles. Also found in the prior art are remote audio controllers having an application program and a transceiver for communicating with a speaker or related device.

However, the prior art does not teach a grill tool which eliminates the need for multiple tools which would require two hands, or requiring the user to clean his or her hands when switching between tools (i.e., between the grill tool and a remote control for controlling music). The present invention fulfills these needs and provides further advantages as described in the following summary.

### SUMMARY OF THE INVENTION

The present invention teaches certain benefits in construction and use which give rise to the objectives described below.

The present invention provides a grill tool for controlling music being streamed from a portable electronic device to a speaker. The grill tool comprises a grill tool head mounted on a rigid elongate handle, and a music playing controller mounted on the rigid elongate handle, the music playing controller having a microcontroller operably connected to a battery. The music player controller further has a means for controlling the music being streamed from the portable electronic device.

A primary objective of the present invention is to provide a grill tool with music player controller having advantages not taught by the prior art.

Another objective is to provide a grill tool with music player controller which allows a user to control audio functions on a speaker while grilling, without switching between tools.

A further objective is to provide a grill tool with music player controller having a detachable controller.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a grill tool having a music player controller, according to one embodiment of the present invention, the music player controller being operative for controlling a music playing device streaming music to speakers via a network;

FIG. 2 is an exploded perspective view of the grill tool of FIG. 1; and

FIG. 3 is block diagram illustrating one embodiment of the music player controller of FIG. 1.

### DETAILED DESCRIPTION OF THE INVENTION

The above-described drawing figures illustrate the invention, a grill tool 10 that includes a music player controller 20 for controlling music being played while grilling or engaged in other related outdoor activities.

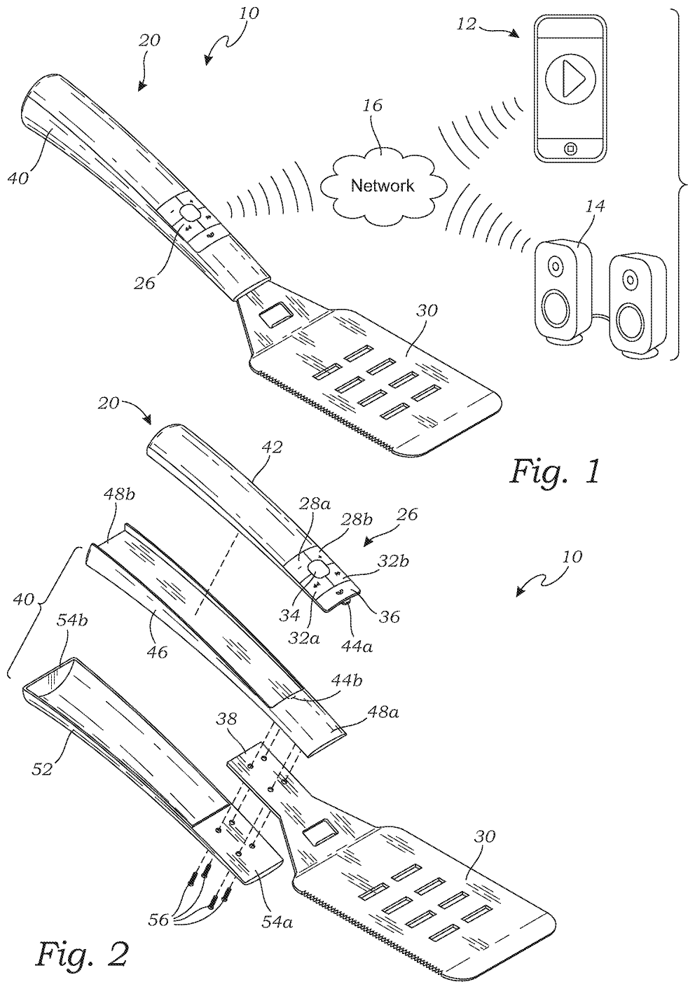

FIG. 1 is a perspective view of the grill tool 10 having the music player controller 20, according to one embodiment of the present invention, the music player controller 20 being operative for controlling a portable electronic device 12 streaming media to speakers 14 via a network 16. For the purposes of this application, “music,” or other similar terms (e.g., “audio,” “media,” etc.) are hereby defined to include any form of sound that may be transmitted to the speaker 14, including songs, telephone calls, audiobooks, or any other similar forms of media known in the art. The portable electronic device 12 may comprise any of a wide range of digital electronic devices, including but not limited to any form of computer, laptop, smart phone, MP3 player, tablet, or any form of electronic device capable of functioning as described herein. In some embodiments, the portable electronic device 12 may be directly connected (e.g., an auxiliary cord) to the speaker, and may comprise hardware in a single unit, or be operably connected via a network, the portable electronic device 12 being discussed in greater detail below. The speaker 14 may be any standard type of speaker capable of transmitting and receiving media, via a network, wired connection, or otherwise, as is well-known in the art.

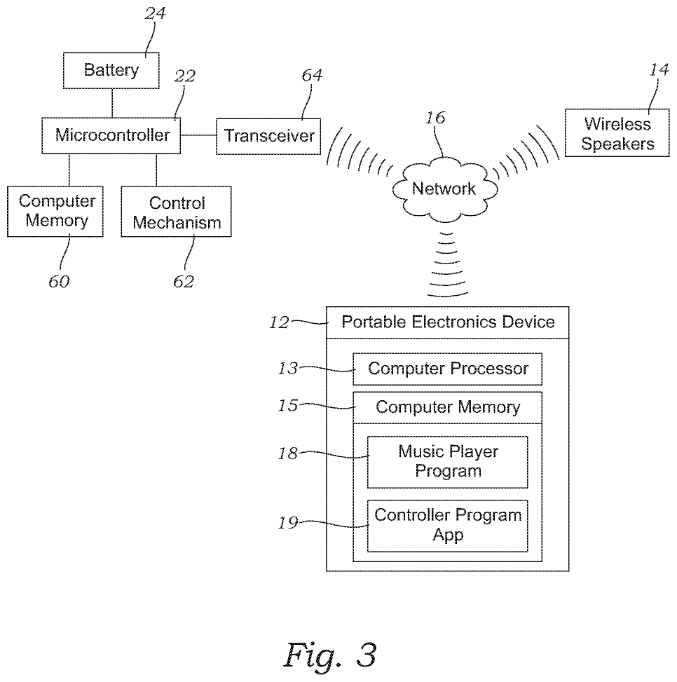

In the embodiment of FIG. 1, the grill tool 10 is in the form of a grilling spatula having a blade 30 attached to a rigid elongate handle 40 at a tang portion 38. In alternative embodiments, the grill tool 10 may have another form of grill tool head attached to the rigid elongate handle 40, for example, fork tines, a scouring brush, tongs, or any other form of grill tool known in the art. As shown in FIG. 1, the rigid elongate handle 40 further includes the music playing controller 20 mounted thereupon, the music playing controller 20 having an elongate rigid housing 42 containing a microcontroller 22 operably connected to a battery or batteries 24 (shown in FIG. 3), and further having a means for controlling 26 the music being streamed from the portable electronic device 12. The means for controlling 26 the music may be in the form of a button-controlled panel, and may include functions such as volume increase 28a and volume decrease 28b, a forward button 32a and a reverse button 32b, play/pause 34, and/or any other similar functions commonly used in the art. While example functions are provided herewith, it should be understood that any variation of functions may be applied to the means for controlling 26 the music, as deemed suitable by the manufacturer.

In this embodiment, the means for controlling 26 further includes a phone answering and hanging up 36 (e.g., button, switch, or other form) for call actuating (either answering a call, or hanging up a call in progress). This button 36 enables a user to control incoming calls while otherwise engaged in grilling. The calls may be directed to the smart phone, and/or via headphones, earbuds, or the like (not shown), which are commonly used in these circumstances.

FIG. 2 is an exploded perspective view of the grill tool with music player controller 10. As discussed above, the rigid elongate handle 40 includes the means for controlling music 26. In the embodiment of FIG. 2, the means for controlling music 26 is mounted on the rigid elongate housing 42 of the music player controller 20 that is detachably mounted on the rigid elongate handle 40 of the grill tool 10.

In this embodiment, the rigid elongate housing 42 nests into the handle 40, and may include a first attachment mechanism 44a (e.g., tab, hook, or any other form of fastener known in the art) for removable attachment to the rigid elongate handle 40. In this embodiment, the upper half 46 of the rigid elongate handle 40 has a first end 48a and a second end 48b, and may include a complimentary attachment mechanism 44b such as a slot, hook, etc. on the first end 48a for removable engagement with the first attachment mechanism 44a.

The rigid elongate handle 40 also has a lower half 52 having a first end 54a and a second end 54b, the first ends 48a and 54a of the upper and lower halves 46 and 52 each being fastened to the tang 38 of the grill tool head 30 via a fastener 56 (e.g., screws, hooks, tabs, etc.).

As shown in FIG. 2, the rigid elongate housing 42 of the music player controller 20 may be detached from the grill tool head 30 and the rigid elongate handle 40, which enables the user to clean the grill tool 10 safely. For example, the grill tool head 30 may be placed in a dishwasher without the possibility of damaging the electronics/batteries within the controller 20. The music player controller 20 may also be detached from the rigid elongate handle 40 for independent use, as is desirable for the user.

FIG. 3 is block diagram illustrating one embodiment of the music player controller 20 of FIG. 1. As shown in FIG. 3 and described above, in this embodiment the music player controller 20 (shown in FIG. 2) includes a microcontroller 22 operatively connected to a battery 24, a computer memory 60 and a control mechanism 62 which provide the means for controlling music 26. The microcontroller 22 of the music player controller 20 is further operably connected to a transceiver 64, which communicates with any form of network 16 (e.g., WiFi, or other form of network) and/or the wireless speakers 14 and the portable electronic device 12.

The portable electronic device 12 comprises a computer processor 13 and a computer memory 15. The computer memory 15 may have installed thereupon a music player program 18 (e.g., a web browser, media player, etc.) capable of running desired media to be played by the speaker 14. The computer memory 15 may additionally include a controller program application 19 designed to enable communication with the transceiver 64 of the music player controller 20.

In use, the user first operably connects (e.g., synchs) the portable electronic device 12 with the speaker 14, either wirelessly or via wired connection, and the music player controller 20 is operably connected with the portable electronic device 12 so that they can communicate, either wirelessly or via wired connection. Music can then be streamed, either wirelessly or via wired connection, to the speaker 14, as controlled by the music player controller 20 of the grill tool 10.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A grill tool for controlling music being streamed from a portable electronic device to a speaker, the grill tool comprising:
a grill tool head mounted on a rigid elongate handle; and
a music player controller mounted on the rigid elongate handle, the music player controller having a microcontroller operably connected to a battery, and further having a means for controlling the music being streamed from the portable electronic device.

2. The grill tool of claim 1, wherein the means for controlling music being streamed includes a play button, a forward button, and a reverse button.

3. The grill tool of claim 1, wherein the means for controlling music being streamed includes a volume increase button and a volume decrease button.

4. The grill tool of claim 1, wherein the means for controlling music being streamed includes a call answer and call end button.

5. The grill tool of claim 1, wherein the means for controlling music is mounted on a rigid elongate housing that is detachably mounted on the rigid elongate handle of the grill tool.

6. A grill tool for controlling music being streamed from a portable electronic device to a speaker, the grill tool comprising:
a grilling spatula having a blade mounted on a rigid elongate handle; and
a music player controller mounted on the rigid elongate handle of the grilling spatula, the music player controller having a microcontroller operably connected to a battery, and further having a means for controlling the music being streamed from the portable electronic device.

7. The grill tool of claim 6, wherein the means for controlling music being streamed includes a play button, a forward button, and a reverse button.

8. The grill tool of claim 6, wherein the means for controlling music being streamed includes a volume increase button and a volume decrease button.

9. The grill tool of claim 6, wherein the means for controlling music being streamed includes a call answer and call end button.

10. The grill tool of claim 6, wherein the means for controlling music is mounted on a rigid elongate housing that is detachably mounted on the rigid elongate handle of the grill tool.
